(19) United States
(12) Patent Application Publication
(10) Pub. No.: US 2022/0033664 A1
(43) Pub. Date: Feb. 3, 2022

(54) MOLDING COMPOSITION AND METHOD FOR MANUFACTURING THREE-DIMENSIONAL SHAPED OBJECT

(71) Applicant: SEIKO EPSON CORPORATION, Tokyo (JP)

(72) Inventors: Kozo SHITAGAMI, CHINO-SHI (JP); Eiji OKAMOTO, MATSUMOTO-SHI (JP); Akihiko TSUNOYA, OKAYA-SHI (JP)

(21) Appl. No.: 17/389,832

(22) Filed: Jul. 30, 2021

(30) Foreign Application Priority Data
Jul. 31, 2020 (JP) 2020-130205

(51) Int. Cl. C09D 11/037; C09D 11/12; C09D 11/108; B33Y 70/00

(52) U.S. Cl. CPC C09D 11/037; C09D 11/12; B33Y 10/00; B33Y 70/00; C09D 11/108

(57) ABSTRACT

A molding composition contains a powder, a wax, an adhesive component, a molding component, and a plasticizer, in which a melt flow rate of the adhesive component at 190° C. is 200 g/10 min or more, and a density of the plasticizer is 1.0 g/cm³ or less.

The present application is based on, and claims priority from JP Application Serial Number 2020-130205, filed Jul. 31, 2020, the disclosure of which is hereby incorporated by reference herein in its entirety.

### BACKGROUND

### 1. Technical Field

The present disclosure relates to a molding composition and a method for manufacturing a three-dimensional shaped object.

### 2. Related Art

A three-dimensional object is formed without machining or casting. For example, JP-A-2000-144205 discloses a manufacturing method of manufacturing a metal or ceramic product by forming a shaped object using a three-dimensional printer of a fused deposition modelling method (FDM method) using a compound containing an inorganic powder as a raw material, and debindering and sintering the shaped object. JP-A-2000-144205 discloses that, according to the manufacturing method, a metal or ceramic product having a shape that cannot be formed by the machining or the casting can be quickly formed, and that the manufacturing method is suitable for small-volume production of the product.

However, when a compound similar to that in metal injection molding (MIM) in the related art is applied to a three-dimensional shaping device, since the compound has a high viscosity and thus insufficient fluidity, an injection amount of the compound injected from the three-dimensional shaping device may be unstable, and accuracy of the shape of the shaped object may be reduced. Therefore, it is required to reduce the viscosity of the compound and obtain good shape accuracy of the shaped object.

### SUMMARY

An aspect of a molding composition according to the present disclosure contains: a powder; a wax an adhesive component, a molding component, and a plasticizer, in which a melt flow rate of the adhesive component at 190° C. is 200 g/10 min or more, and a density of the plasticizer is 1.0 g/cm³ or less.

An aspect of a method for manufacturing a three-dimensional shaped object according to the present disclosure includes: a layer forming step of discharging the molding composition according to the aspect described above, in which the layer forming step is performed a plurality of times.

### DESCRIPTION OF EXEMPLARY EMBODIMENTS

Hereinafter, some embodiments of the present disclosure will be described. The embodiment to be described below describes an example of the present disclosure. The present disclosure is not limited to the following embodiments at all, and includes various modifications implemented without departing from the gist of the present disclosure. It should be noted that all of configurations to be described below are not necessarily essential configurations of the present disclosure.

### 1. MOLDING COMPOSITION

A molding composition according to the present embodiment contains a powder, a wax, an adhesive component, a molding component, and a plasticizer. A melt flow rate of the adhesive component at 190° C. is 200 g/10 min or more, and a density of the plasticizer is 1.0 g/cm³ or less. Hereinafter, each component will be described. In the present specification, components other than the powder contained in the molding composition may be collectively referred to as a “binder”.

### 1.1. Powder

The molding composition according to the present embodiment contains a powder. The powder is a component, a part or all of which remains in a shaped object after the molding composition is debindered and sintered. That is, the powder used in the molding composition according to the present embodiment may be any powder as long as the powder can remain even when the binder is lost due to debindering and sintering, and examples thereof include an inorganic powder and an organic powder.

Examples of the inorganic powder include a metal powder, a ceramic powder, a cermet powder, a metal oxide powder, and an intermetallic compound powder, and may be a powder obtained by mixing two or more of these powders.

Specifically, examples of the metal powder include powders of pure iron, an iron-based alloy such as iron-nickel, iron-cobalt, iron-silicon, and stainless steel, tungsten, tungsten carbide (WC), a cemented carbide (WC—Co-based alloy and the like), an aluminum alloy, copper, and a copper alloy.

Examples of the ceramic powder and the metal oxide powder include oxides such as Al₂O₃, BeO, TiO₂, and ZrO₂, carbides such as TiC, ZrC, and B₄C, borides such as CrB and ZrB₂, and nitrides such as TiN and ZrN. Further, examples of the cermet powder include an Al₂O₃—Fe-based powder, a TiC—Ni-based powder, a TiC—Co-based powder, and a B₄C—Fe-based powder.

Examples of the organic powder include a silicone elastomer powder, a silicone powder, a silicone resin-coated silicone elastomer powder, a polyamide resin powder (nylon powder), a polyethylene powder, a polystyrene powder, a styrene/acrylic acid copolymer resin powder, a benzoguanamine resin powder, a polytetrafluoroethylene powder, and a cellulose powder.

The powder used in the molding composition of the present embodiment is preferably an inorganic powder because a combustion temperature, a decomposition temperature, an evaporation temperature, and the like are sufficiently higher than those of the binder. Further, among the inorganic powders, the metal powder is more preferable because the surface easily melts during the sintering and a shape of the shaped object which is a sintered body can be formed with high accuracy.

A blending amount of the powder in the molding composition is preferably 64.8 vol % or more with respect to a total volume of the molding composition. In other words, a filling rate on a volume basis of the powder in the molding composition is preferably 64.8% or more. When the blending amount of the powder is within this range, the components other than the powder are reduced, and a volume change during heating and cooling is reduced to be smaller. Further, when the blending amount of the powder is within this range, components lost during the debindering and the sintering are further reduced, and a shaped object having a higher density can be obtained.

### 1.2. Wax

The molding composition contains a wax. The wax has a function of improving fluidity when the molding composition is extruded or injected from a three-dimensional shaping device. The wax is a component that constitutes the binder and disappears when the molding composition is debindered and sintered.

Examples of the wax include a natural wax and a synthetic wax. Among these, examples of the natural wax include: a vegetable wax such as candelilla wax, carnauba wax, rice wax, wood wax, and jojoba oil; an animal wax such as beeswax, lanolin, and spermaceti; and a mineral wax such as montan wax, ozokerite, and ceresin. Examples of the synthetic wax include a petroleum wax such as paraffin wax, microcrystalline wax, and petrolatum. The wax may be used alone or in combination of two or more kinds thereof as exemplified above.

A blending amount of the wax in the molding composition is 25 mass % or more and 35 mass % or less, preferably 26 mass % or more and 33 mass % or less, more preferably 27 mass % or more and 30 mass % or less, and still more preferably 27 mass % or more and 29 mass % or less, with respect to 100 mass % of the component excluding the powder in the molding composition, that is, the binder. When the blending amount of the wax is within this range, the molding composition has excellent fluidity.

### 1.3. Adhesive Component

The molding composition contains an adhesive component. The adhesive component constitutes the binder. The adhesive component has a function of bonding particles of the powder to each other in the molding composition. Further, a small amount of the adhesive component remains in the molding composition after the debindering. Accordingly, the adhesive component has a function of bonding the particles of the powder to each other and maintaining the shape of the shaped object in a debindered state before the sintering. The adhesive component is a component that disappears when the molding composition is sintered, similar to other binders.

A melt flow rate (MFR) of the adhesive component at 190° C. is 200 g/10 min or more. When the MFR of the adhesive component is 200 g/10 min or more, the molding composition can have high fluidity.

Examples of the adhesive component include a copolymer of two or more kinds of monomers selected from an ethylene-based monomer, an acrylic monomer, and a vinyl-based monomer. More specifically, examples of the adhesive component include an ethylene-glycidyl (meth)acrylate copolymer and an ethylene-vinyl acetate copolymer.

The MFR of the adhesive component can be adjusted, for example, by changing a molecular weight of a polymer compound constituting the adhesive component.

The melt flow rate of the adhesive component can be measured under conditions of 190° C. and 21.2 N load (2160 g load) based on JIS K 7210, and under conditions of 190° C. and 21.2 N load (2160 g load) based on ASTM D1238 and ISO1133.

A blending amount of the adhesive component in the molding composition is 20 mass % or more and 35 mass % or less, preferably 22 mass % or more and 33 mass % or less, more preferably 23 mass % or more and 30 mass % or less, and still more preferably 25 mass % or more and 27 mass % or less, with respect to 100 mass % of the component excluding the powder in the molding composition, that is, the binder. When the blending amount of the adhesive component is within this range, the shaped object shaped using the molding composition can have more excellent shape stability.

### 1.4. Molding Component

The molding composition contains a molding component. The molding component constitutes the binder. A small amount of the molding component remains in the molding composition after the debindering. Accordingly, the molding composition has a function of fixing the particles of the powder to each other and maintaining the shape of the shaped object in the debindered state before the sintering. The molding component is a component that disappears when the molding composition is sintered, similar to other binders.

The molding component is preferably formed by a polymer compound. The polymer compound is not particularly limited, and examples thereof include polystyrene, polyacetal, polyoxymethylene, polyoxyethylene, polyacrylic acid, polyacrylic acid ester, an acrylonitrile-butadiene-styrene copolymer (ABS), polypropylene, polyamide, polybutylene terephthalate, polyethylene terephthalate, polycarbonate, an acrylonitrile-styrene copolymer, an alkyl (meth)acrylate polymer, copolymers of monomers constituting these, and modified or unmodified polymers of these polymer compounds. Further, the molding component may be a blend of two or more kinds of the polymer compounds exemplified above.

When the molding composition contains the polymer compound as the molding component, a weight average molecular weight of the polymer compound is preferably 4000 or less. When the molecular weight of the polymer compound of the molding component is 4000 or less, the fluidity of the molding composition can be further improved. Accordingly, the shaped object having good shape accuracy can be formed more quickly and stably. Further, when the weight average molecular weight is within this range, a softening point can also be lowered, and therefore from this viewpoint, the fluidity of the molding composition can be further enhanced.

A blending amount of the molding component in the molding composition is 25 mass % or more and 35 mass % or less, preferably 27 mass % or more and 33 mass % or less, more preferably 28 mass % or more and 32 mass % or less, and still more preferably 29 mass % or more and 31 mass % or less, with respect to 100 mass % of the component excluding the powder in the molding composition, that is, the binder. When the blending amount of the molding component is within this range, the shaped object shaped using the molding composition can have more excellent shape stability.

### 1.5. Plasticizer

The molding composition according to the present embodiment may contain a plasticizer. The plasticizer has a function of promoting mixing of the binder components and mixing of the molding composition. Accordingly, the molding composition can be made into a uniform mixture.

Examples of the plasticizer include bis(2-ethylhexyl) terephthalate (specific gravity: 0.984 (density: 0.981), boiling point: 416° C.), diisononyl phthalate (specific gravity: 0.976 (density: 0.981), boiling point: 403° C.), diundecyl phthalate (specific gravity: 0.955 (density: 0.952), boiling point: 523° C.), diisodecyl phthalate (density: 0.970, boiling point: 420° C.), bis(2-ethylhexyl) adipate (specific gravity: 0.927 (density: 0.924), boiling point: 335° C.), diisononyl adipate (specific gravity: 0.924 (density: 0.921), boiling point: 250° C. or higher), di-n-alkyl adipate (specific gravity: 0.926 (density: 0.923), boiling point: 198° C. to 244° C. (665 Pa)), diisodecyl adipate (specific gravity: 0.92 (density: 0.917), boiling point: 244° C. (0.667 kPa)), and bis(2-butoxyethyl) adipate (specific gravity: 1.00 (density: 0.997), boiling point: 217° C./1.5 kPa). The plasticizers exemplified here also have good environmental compatibility.

When the molding composition contains the plasticizer, a density of the plasticizer is preferably 1.0 g/cm³ or less, more preferably 0.990 g/cm³ or less, and still more preferably 0.985 g/cm³ or less. When such a plasticizer is contained, voids at a molecular level can be generated in the composition by the plasticizer, so that the fluidity of the composition can be further improved.

When the molding composition contains the plasticizer, a blending amount of the plasticizer is 5 mass % or more and 25 mass % or less, preferably 10 mass % or more and 20 mass % or less, more preferably 13 mass % or more and 19 mass % or less, and still more preferably 15 mass % or more and 17 mass % or less, with respect to 100 mass % of the component excluding the powder in the molding composition, that is, the binder. When the blending amount of the plasticizer is within this range, the molding composition can have more excellent fluidity.

### 1.6. Ratio of Binder

When it is considered to decrease the viscosity of the molding composition, it is considered that the viscosity is decreased by increasing a ratio of the binder in the molding composition. However, when only an amount of the binder is increased as described above, the binder is lost due to the sintering, and thus thermal shrinkage of the shaped object is likely to occur, and warpage, cracking, and distortion of the shaped object are likely to occur.

In contrast, in the molding composition according to the present embodiment, when the filling rate on a volume basis of the powder is high, for example, 64.8% or more, the thermal shrinkage of the shaped object can be reduced. Further, when the blending amount of the binder is less than about 35.2 vol %, the amount of components lost during debindering and sintering is small. Accordingly, a shaped object having a high density can be obtained.

In general, when the amount of the binder is reduced to be low, the viscosity of the molding composition may increase, and the injection amount of the molding composition from the molding device may decrease. However, in the molding composition according to the present embodiment, by finding a specific composition of the binder, it is possible to reduce the amount of the binder to be low and to obtain a viscosity characteristic and an injection amount characteristic which are equal to or more than those obtained when a larger amount of a binder is blended.

In order to stably perform a high temperature shaping process in a scale of several to several tens of hours in three-dimensional shaping, a material having a high boiling point is often blended in the molding composition to be used. A material having a relatively low boiling point in the composition of the binder in the molding composition according to the present embodiment is the wax having the fluidity function and the plasticizer blended as necessary. In general, when the material having a high boiling point is used, the viscosity is likely to increase, and it is difficult to achieve both suitability for a high-temperature process and a reduction in viscosity. However, according to the molding composition of the present embodiment, the viscosity of the molding composition can be reduced to be low and good fluidity can be obtained while using the material having a high boiling point.

### 1.7. Other Functions and Effects

In an injection molding machine, as described in Japanese Patent No. 5970895, Japanese Patent No. 5970794, and Japanese Patent No. 5857688, an injection pressure of 5 MPa to 500 MPa is generally required. However, when the molding composition according to the present embodiment is used, the injection pressure can be 5 MPa or less at a shear rate of 0.1 s⁻¹. Accordingly, a decrease in injection amount can be reduced while improving the filling rate of the powder.

The molding composition according to the present embodiment contains the binder as described above, and the binder contains a plurality of types of components. Accordingly, timings at which the components melt, decompose, and evaporate in the process of the debindering and the sintering are different from each other. For example, when the molding composition is heated to about 500° C. and debindered, a fluid component and the plasticizer are decomposed at a temperature of about 200° C. to 300° C., and the adhesive component and the molding component are decomposed at a temperature of about 300° C. to 500° C. Thus, the shape stability during debindering can be further enhanced.

### 2. EXAMPLES AND COMPARATIVE EXAMPLES

Hereinafter, the present disclosure will be described in more detail with reference to Examples and Comparative Examples, and various modifications can be made to the present disclosure without departing from the gist of the present disclosure. The present disclosure is not limited to the following Examples. With respect to the amount of component, terms “%” and “part” are based on mass unless otherwise specified.

### 2.1. Preparation of Molding Composition

The molding composition of each example was prepared as follows.

Using a pressure kneader (TD0.3-3M, manufactured by Toshin Co., Ltd.), the component was kneaded at a temperature of 110° C., a rotation speed of 30 rpm, and a pressure of 0 MPa ((1) about 900 g of a metal powder was added and kneaded for 5 minutes, (2) the wax, the adhesive component, and the molding component were added and then the remaining metal powder was added and kneaded for 3 minutes, and (3) the plasticizer was added and kneaded for 2 minutes), and then was kneaded at a temperature of 110° C., a rotation speed of 30 rpm, and a pressure of 0.5 MPa. A component composition of each example is shown in Table 1.

TABLE 1
Table 1:

| | | | | Example 1 | Example 2 | Example 3 | Example 4 | Example 5 |
|---|---|---|---|---|---|---|---|---|
| Binder | Wax | Material name | | PW130 | PW130 | PW115 | PW115 | PW130 |
| | | Blending ratio | [mass %] | 28.0 | 33.0 | 28.0 | 28.0 | 33.0 |
| | Adhesive | Material name | | CG-5001 | CG-5001 | CG-5001 | CG-5001 | LOTADER 8210 |
| | component | MFR | [g/10 min] | 380 | 380 | 380 | 380 | 200 |
| | | Blending ratio | [mass %] | 26.0 | 24.0 | 26.0 | 26.0 | 24.0 |
| | Molding | Material name | | ST-95 | ST-95 | ST-95 | ST-95 | ST-95 |
| | component | Blending ratio | [mass %] | 30.0 | 27.0 | 30.0 | 30.0 | 27.0 |

| | | | | | | |
|---|---|---|---|---|---|---|
| Plasticizer | Compound abbreviation | DIDP | DIDP | DIDP | DIDP | DIDP |
| | Plasticizer density | 0.970 | 0.970 | 0.970 | 0.970 | 0.970 |

| | | | | | | |
|---|---|---|---|---|---|---|
| Blending ratio | [mass %] | 16.0 | 16.0 | 16.0 | 16.0 | 16.0 |

| | | | | | | | |
|---|---|---|---|---|---|---|---|
| Molding | Number of external binders for | [Part by | 6.5 | 6.5 | 6.5 | 6.0 | 6.5 |
| composition | metal powder | mass] | | | | | |
| | Normalized pellet viscosity | [—] | 1.0 | 0.7 | 1.2 | 1.3 | 1.2 |
| | (based on Example 1) | | | | | | |
| | Filling rate of metal powder | [vol %] | 65 | 65 | 65 | 67 | 65 |

| | | | | | | |
|---|---|---|---|---|---|---|
| Injection state (based on Example 1 basis) | [—] | A | A | A | A | A |

| | | | Comparative | Comparative | Comparative |
|---|---|---|---|---|---|
| | | | Example 1 | Example 2 | Example 3 |
| Binder | Wax | Material name | PW130 | PW115 | PW115 |

| | Blending ratio | [mass %] | 28.0 | 28.0 | 28.0 |
|---|---|---|---|---|---|
| Adhesive | Material name | | BF-7B | CG-5001 | BF-7M |
| component | MFR | [g/10 min] | 7 | 380 | 7 |
| | Blending ratio | [mass %] | 26.0 | 26.0 | 26.0 |
| Molding | Material name | | ST-95 | ST-95 | ST-95 |
| component | Blending ratio | [mass %] | 30.0 | 30.0 | 30.0 |

| | | | | |
|---|---|---|---|---|
| Plasticizer | Compound abbreviation | DIDP | DBP | DBP |
| | Plasticizer density | 0.970 | 1.048 | 1.048 |

| | | | | |
|---|---|---|---|---|
| Blending ratio | [mass %] | 16.0 | 16.0 | 16.0 |

| | | | | | |
|---|---|---|---|---|---|
| Molding | Number of external binders for | [Part by | 6.5 | 6.5 | 6.5 |
| composition | metal powder | mass] | | | |
| | Normalized pellet viscosity | [—] | 3.0 | 2.4 | 3.1 |
| | (based on Example 1) | | | | |
| | Filling rate of metal powder | [vol %] | 65 | 65 | 65 |

| | | | | |
|---|---|---|---|---|
| Injection state (based on Example 1 basis) | [—] | B | B | B |

In the table, materials and compounds are as follows.
PW130: Paraffin Wax 130 (manufactured by Nippon Seiro Co., Ltd., melting point: 56° C.)
PW115: Paraffin Wax 115 (manufactured by Nippon Seiro Co., Ltd., melting point: 48° C.)
CG-5001: BONDFAST (registered trademark) CG-5001 (manufactured by Sumitomo Chemical Co., Ltd., MFR = 380 g/10 min)
LOTADER 8210: LOTADER (registered trademark) 8210 (ARKEMA Corporation, MFR = 200 g/10 min)
BF-7M: BONDFIRST (registered trademark) BF-7M (manufactured by Sumitomo Chemical Co., Ltd., MFR= 7 g/10 min)
ST-95: HIMER (registered trademark) ST-95 (manufactured by Sanyo Chemical Industries, Ltd., polystyrene, weight average molecular weight = 4000)
DIDP: diisodecyl phthalate (manufactured by Kanto Chemical Co., Inc. (density: 0.970, boiling point: 420° C.))
DBP: dibutyl phthalate (manufactured by Kanto Chemical Co., Inc. (density: 1.048))
Metal powder: (SUS630, PF-5K D50 to 4 pm) manufactured by Epson Atmix Corporation.

The molding composition kneaded as described above was pelletized under a condition of 50° C. to 100° C. using HAND TRUDER (PM-1, manufactured by Toyo Seiki Seisaku-sho, Ltd.).

### 2.2. Evaluation of Molding Composition

### 2.2.1. Viscosity

The viscosity of the molding composition of each example was measured using a rheometer (Rheosol G3000NT-HR, manufactured by UBC). A cone plate having a diameter of 18 mm was used to measure the viscosity up to a shear rate of around 100 s⁻¹ at 100° C., the viscosity at a shear rate of 0.1 s⁻¹ was read, and a value normalized by the viscosity of Example 1 was shown in Table 1.

### 2.2.2. Evaluation of Injection Amount

The molding composition of each example was introduced into the three-dimensional shaping device and injected for 30 seconds under conditions of 125° C. and 2 MPa. A weight of the injected composition was measured, and the injection amount of each example was calculated. An injection amount of 80% or more of the injection amount of Example 1 was determined as “A”, and an injection amount of less than 80% was determined as “B”.

### 2.2.3. Evaluation of Warpage

Using the three-dimensional shaping device, a shaped object having a short axis width of 5 mm, a long axis width of 65 mm, and a thickness of 2 mm was shaped using the molding composition of each example. Thereafter, each test piece was placed on a horizontal table, and an image of the test piece was captured from a direction along the short axis using a camera. From the captured image, a distance £x in a thickness direction between an end portion of the long axis width and the table was measured at the two end portions. Thereafter, an angle θ of warpage was calculated based on the following formula (1).

tan θ=2×Δx/65 (1)

### 2.2.4. Evaluation Result

The molding compositions each containing the powder, the wax, the adhesive component, the molding component, and the plasticizer, in which the melt flow rate of the adhesive component at 190° C. is 200 g/10 min or more, and the density of the plasticizer is 1.0 g/cm³ or less of Examples had remarkably lower viscosities and quite better injection amounts than the compositions of Comparative Examples.

Further, when a metal filling rate was about 55%, the warpage was observed in the shaped object. Since the filling rate was more than 64.8% and the filling rate was high at all levels in Examples and Comparative Examples described in Table 1, a degree of warpage was almost zero. As a result, an effect of reducing the number of binder parts was observed.

The present disclosure includes a configuration substantially the same as the configuration described in the embodiment such as a configuration having the same function, method, and result and a configuration having the same object and effect. The present disclosure includes a configuration in which a non-essential portion of the configuration described in the embodiment is replaced. The present disclosure includes a configuration having the same action effect as the configuration described in the embodiment, or a configuration capable of achieving the same object. Further, the present disclosure includes a configuration in which a known technique is added to the configuration described in the embodiment.

The following contents are derived from the embodiment and the modification described above.

An aspect of a molding composition contains a powder, a wax, an adhesive component, a molding component, and a plasticizer, in which a melt flow rate of the adhesive component at 190° C. is 200 g/10 min or more, and a density of the plasticizer is 1.0 g/cm³ or less.

According to the molding composition, since the viscosity is low, the fluidity is good. Accordingly, when the molding composition is applied to the three-dimensional shaping device, the shaped object having good shape accuracy can be formed more quickly and stably.

In the aspect of the molding composition described above, a powder may have a filling rate on a volume basis of 64.8% or more.

The molding composition contains a small amount of components other than the powder. Therefore, according to the molding composition, the thermal shrinkage is less likely to occur as compared to a case where the amount of components other than the powder is large. Further, according to the molding composition, the amount of components lost during the debindering and the sintering is small. Accordingly, the shaped object having a high density can be obtained.

In the aspect of the molding composition described above, the molding component may contain a polymer compound, and a weight average molecular weight of the polymer compound may be 4000 or less.

According to this molding composition, since the molding composition contains the molding component having a low molecular weight, the fluidity is further improved. Accordingly, the shaped object having good shape accuracy can be formed more quickly and stably.

In the aspect of the molding composition described above, the powder may be a metal powder.

According to the molding composition, a sintered body of the metal powder can be quickly and stably formed with high shape accuracy.

An aspect of a method for manufacturing a three-dimensional shaped object includes a layer forming step of discharging the molding composition described above, in which the layer forming step is performed a plurality of times.

According to the three-dimensional shaped object manufacturing method, since the injection amount can be stably maintained, a three-dimensional shaped object having high accuracy can be shaped.

What is claimed is:

1. A molding composition comprising:
a powder;
a wax;
an adhesive component;
a molding component; and
a plasticizer, wherein
a melt flow rate of the adhesive component at 190° C. is 200 g/10 min or more, and
a density of the plasticizer is 1.0 g/cm³ or less.

2. The molding composition according to claim 1, wherein
the powder has a filling rate on a volume basis of 64.8% or more.

3. The molding composition according to claim 1, wherein
the molding component contains a polymer compound, and
the polymer compound has a weight average molecular weight of 4000 or less.

4. The molding composition according to claim 1, wherein
the powder is a metal powder.

5. A method for manufacturing a three-dimensional shaped object, the method comprising:
a layer forming step of discharging the molding composition according to claim 1, wherein
the layer forming step is performed a plurality of times.
